(19) United States
(12) Patent Application Publication
(10) Pub. No.: US 2005/0240417 A1
(43) Pub. Date: Oct. 27, 2005

(54) Monitoring usage of electronic equipment

(76) Inventor: Dave Savage, Buckinghamshire (GB)

Correspondence Address: NIXON & VANDERHYE, PC, 901 NORTH GLEBE ROAD, 11TH FLOOR, ARLINGTON, VA, 22203, US

(21) Appl. No.: 10/516,092

(22) PCT Filed: May 30, 2003
(86) PCT No.: PCT/GB03/02360

§ 371 Date: May 2, 2005

(30) Foreign Application Priority Data
May 31, 2002 (GB) 0212718.1
Jan. 29, 2003 (GB) 0302081.5

(51) Int. Cl. G06F 17/60

(52) U.S. Cl. 705/1

(57) ABSTRACT

The invention relates to a method for the rental of image projectors, in which a customer is provided with an image projector over an extended period. In accordance with embodiments of the invention, the image projector is arranged to sense and monitor usage during the extended period and, in at least one aspect of the invention, transmit a signal indicative of the same to a remote processing system. The remote processing system evaluates a cost corresponding to the usage and the customer is charged accordingly. The transmitted signal includes data relating to a temporal characteristic of the monitored usage within the extended period, in particular the time that the equipment was actually in use, so that the customer is only charged for the time that the image projector was actually in use.

### FIELD OF THE INVENTION

This invention concerns improvements relating to electronic equipment, in particular, but not exclusively, image projectors.

### BACKGROUND

Many rental companies provide a rental service involving rental of image projectors to commercial entities. Typically, the customer may be a hotel or conference centre which allows its clients to use the image projectors during meetings. The current standard system is known as “dry hire” and involves the supply of image projectors via a booking system. In the dry hire system, the rental company delivers the equipment according to a booking request, and the customer is charged in accordance with a published rate card on a full day basis or a multiple thereof. Various discounts are available depending on duration of hire. The equipment is then collected at a pre-arranged time on a pre-arranged day by the hire company. Generally, hire of image projectors is only possible in blocks of one full day due to the logistics of delivering and removing the equipment, and payment paperwork must be completed for every transaction. Since these steps are repeated in respect of each such rental activity, dry hire involves a relatively large amount of costly and complex communication, administration, mobilization and logistics.

In the case of image projectors, companies who rent the equipment are typically event facilitators (e.g. hotels and the like), who provide facilities and services to individuals or groups wishing to hold meetings, conferences or presentations etc. Thus event facilitators themselves hire out the rented equipment; as a result, an event facilitator is not in control of when and how the image projectors are used, instead being dependent on demand for the equipment. The afore-mentioned problem of a lack of flexibility is thus particularly acute when the demand for presentations and conferences fluctuates over a period of time.

It would be desirable to provide a system for the hire of image projectors which is less complex and more efficient in its administration and whereby the rental of the equipment can be made more convenient for a customer.

### SUMMARY OF INVENTION

According to a first aspect of the present invention there is provided apparatus for monitoring usage of an image projector, the apparatus comprising:
a usage sensor arranged to sense usage of the image projector; and
a control unit adapted to monitor usage of the image projector in response to an output from said usage sensor.

Embodiments of the invention are concerned with monitoring and recording usage of image projectors and providing access to statistics relating to such usage so that a rental charge is levied which accords with an amount of usage of an image projector. It is noted that usage monitoring systems have been proposed in the past in relation to rental of other types of equipment, such as rental televisions, however such systems were not considered for use in relation to image projectors, and are generally unsuitable for use in relation to image projectors.

As stated in the introductory section, conventional dry hire charging systems are inherently inflexible, since a flat daily rate is applied, irrespective of actual use during the rental period. This arises from the fact that, with current image projectors on hire, no usage data is monitored or collected to provide a more flexible charging system. In embodiments of the invention, usage data are captured in image generating equipment by at least one of various monitoring methods and transmitted, via a transmitting component, to an administration centre. Preferably the transmitting component sends the data to the administration centre using wireless technologies which removes the need for fixed line connections to the image projector. Alternately, the data may be read by a reader which is can be connected to the usage monitoring control unit. A billing application can be run on a server computer, and can be made accessible via the Internet, or any other publicly accessible network. The billing application evaluates costs associated with the usage of the image projector and this is made available, either on request, or automatically, to a customer.

In at least one arrangement the control unit is arranged to output data relating to a temporal characteristic of the sensed usage, such as duration of usage, and, for example, specifies a start time and an end time of one or more periods of usage.

A usage sensor may be a software function, integrated into part of the control function of the image projectors, or may be a device hardwired into the image projectors. Alternatively the usage sensor may be a unit that is removably connected to the image projectors and is adapted to sense radiation emitted, for example, as a result of an image being generated by the equipment.

Preferably the apparatus includes a data transmitter for transmitting the output data either wirelessly, via SMS, GPRS and the like, or via a fixed connection by means of a modem or an Ethernet link. According to a further aspect there is provided a data processing system for processing data relating to usage of audio-visual equipment, the data processing system comprising:
a data receiver arranged to receive said data indicative of usage of audio-visual equipment;
accounting means arranged to evaluate a cost associated with said usage on the basis of a predetermined charging function; and
output means arranged to output the evaluated cost,
wherein said received data includes data relating to a temporal characteristic of the usage of the audio-visual equipment.

The data processing system may be in the form of a software-implemented billing application that is preferably located remote from the image projectors.

Thus according to the invention, billing is based on actual usage of the equipment and not to period of hire. With equipment available that embodies these aspects of the invention, customers are far more likely to enter into longer term contractual agreements in respect of the equipment. As a result such equipment can be kept at the customer's premises on a long term basis, removing the need for the rental company to collect and deliver it on a short-term basis.

In the following description the term “customer” is used to denote the party that has entered into a contractual agreement with a rental company in respect of the image projector, and may be referred to as an account administrator.

Further aspects of the invention are set out in the appended claims, and features and advantages of the present invention will become apparent from the following description of preferred embodiments of the invention, which is given by way of example only and made with reference to the accompanying drawings.

### BRIEF DESCRIPTION OF FIGURES

FIG. 1 is a schematic diagram showing an overview of an operating environment within which embodiments of the invention operate;

FIG. 2 is a schematic diagram showing components of image projectors according to an embodiment of the invention;

FIG. 3a is a flow diagram showing steps carried out by the image projectors of FIG. 2;

FIG. 3b is an illustrative diagram showing an example of data stored by the image projectors shown in FIG. 2;

FIG. 4 is a flow diagram showing further steps carried out by image projectors of FIG. 2;

FIG. 5 is a schematic diagram showing an arrangement of a remote data receiver and data processing system according to an embodiment of the invention;

FIG. 6 is a flow diagram showing steps carried out by the remote data receiver and data processing system of FIG. 5;

FIG. 7a is a flow diagram showing further steps carried out by the remote data receiver and data processing system of FIG. 5;

FIG. 7b is an illustrative diagram showing an example of a format of data output by the remote data receiver and data processing system of FIG. 5;

FIG. 8 is a flow diagram showing further steps carried out by remote data receiver and data processing system of FIG. 5;

FIG. 9 is a schematic diagram showing components of image projectors according to a second embodiment of the invention;

FIG. 10 is a circuit diagram illustrating components of a monitoring unit in accordance with a further embodiment of the invention; and

FIG. 11 is a circuit diagram illustrating components of a readout unit in accordance with the further embodiment of the invention.

### DETAILED DESCRIPTION OF DRAWINGS

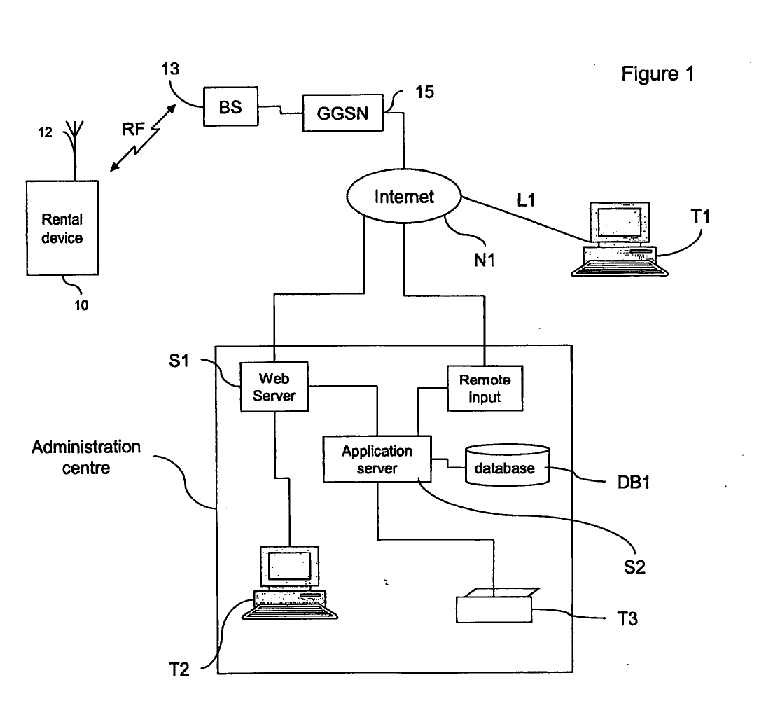

Embodiments of the invention will now be described in more detail. A first embodiment will be described with reference to FIGS. 1 to 8.

Referring to FIG. 1, at a system level, the communications environment within which embodiments of the invention can operate comprises a cellular network comprising a base station 13, and a GPRS (General Packet Radio Services) network including a Gateway GPRS Support Node (GGSN) 15 The GGSN 15 is a network element that provides an interface between the GPRS network and external data networks, such as the Internet N1 or private networks. The GGNS 15 receives data packets from mobile devices, and forwards them, in a known manner, through the Internet N1 or private networks.

The Internet N1 is connected to an administration centre, which in one embodiment of the invention houses several computer terminals including: a web server S1; an application server S2, on which a billing application according to the invention is stored; a user terminal T2, which is arranged to access, locally, the web server S1; and a printer T3, which can be used to print data viewed by the user at terminal T2. The configuration of servers S1, S2 shown in FIG. 1 is merely illustrative of one server arrangement; the skilled person would realise for example that the functionality provided by the web server and the application server could be combined on a single terminal.

Terminal T1 is a remote terminal that can communicate with web server S1 in order to access applications running on the application server. Remote terminal T1 is arranged to access web server S1 via a link L1, which is facilitated through one of the known hardware connection methods e.g. modem, ISDN, LAN and supports a request protocol such as hypertext transfer protocol (HTTP). The remote terminal T1 is arranged to run a browser that receives data from the web server S1 (e.g. via the Hypertext Markup Language (HTML) or the eXtensible Markup Language (XML), or any variants thereof), to interpret the received data and to display the same on the browser for viewing by the user. In the event that the functionality provided by the web server and application server is combined as a single server application running on a single machine, the remote terminal T1 could be arranged to run a bespoke client application that is configured to co-operate with the combined server application.

Typically a customer will access the billing application via a remote terminal such as T1 while an account administrator will access the application via the local terminal T2.

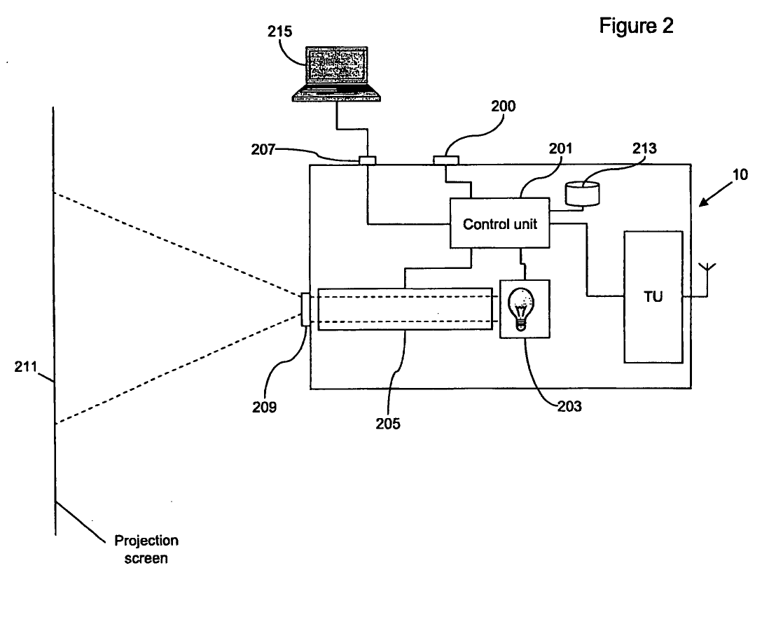

Referring to FIG. 2, in this embodiment a video image projector 10 comprises: an on/off button 200; a control unit 201 for controlling operation of the device 10; a lamp 203 providing a display illumination source; a light modulator 205 for modulating the light from the source. The device 10 is arranged to receive data signals from, for example, a laptop computer 215 via display data input 207. The modulator 207 is controlled in accordance with display data input 207 or internal display data; an output lens 209; and a transmission unit TU. These signals are processed in a known manner by the control unit 201 and projected via the lamp 203, modulator 205 and output lens 209 onto a projector screen 211.

The device 10 can operate in one of two modes whilst a power supply (not shown) is connected: a standby mode, in which the control unit 201 is active but the lamp 203 is normally switched off, and in a display mode, in which the control unit is active but the lamp 203 is switched on. After a period of non-use, or if a blank signal is received via input 207, the device will automatically enter standby mode, in which the lamp is powered off. If a control element, such as the on-off button, is then again actuated, or if an image data signal is received via input 207, the device comes out of standby mode and switches the lamp 203 on once again. In accordance with embodiments of the invention, a usage count is incremented when the device is in active mode (when an image is being projected), and not standby mode (when no image is being projected).

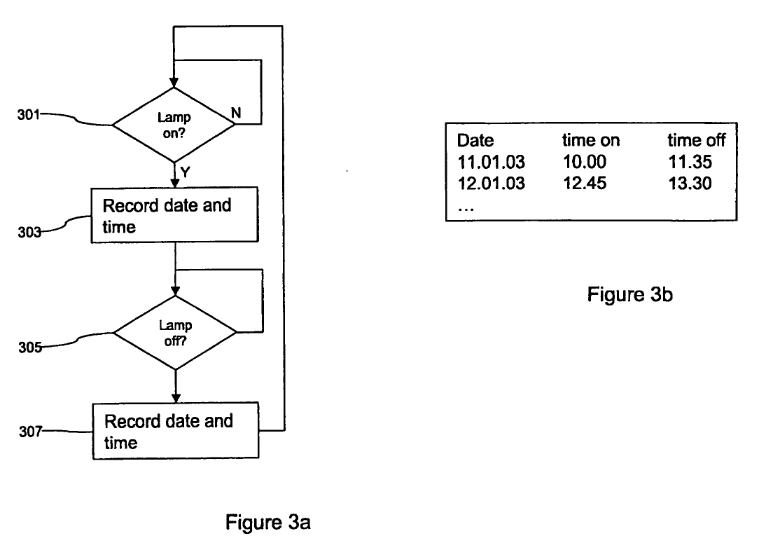

In addition to the conventional programs constituting the control unit 201, the control unit 201 comprises a computer program, or a suite of computer programs, arranged to monitor the utility status of image projector 10 and to store data indicative of the amount of time that the lamp is powered on in a local non-volatile memory 213. In use, and referring to FIG. 3a, the control unit 201 monitors the status of the lamp 203 (step 301), and, when the lamp is identified to have been powered on, the control unit records (step 303), in local memory 213, the date and time corresponding to the instant at which the lamp was powered on. The control unit then reverts (step 305) to monitoring the status of the lamp 203, so as to identify when the lamp is powered off. When the lamp is identified to have been powered off, the control unit 201 records (step 307) the date and time, again by storing this data in the local memory 213. An example of the format of data in the local memory 213 is shown in FIG. 3b.

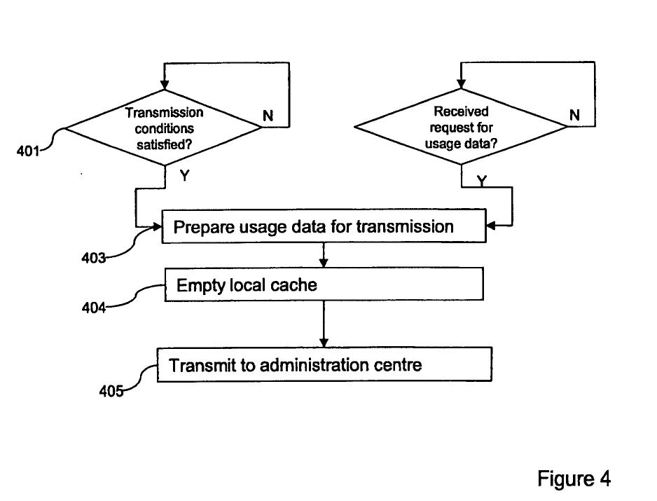

In one arrangement, the control unit 201 is arranged to transmit stored usage data to the administration centre, via the transmission unit TU, when certain specified conditions have been satisfied. These conditions may be based on elapsed time intervals and/or trends in usage data, and are described in more detail below with reference to FIG. 4. Since, in the present embodiment, data are transmitted using the GPRS communication service, the control unit 201 includes packetising means for packetising the usage data stored in the local memory 213; in the event that the administration centre wishes to verify the source of packets purporting to emanate from image projectors 10 leased by the administration centre, the control unit 201 of such image projectors 10 may also include means for encrypting the packetised data. In any event, the packets include data identifying the image projector 10 associated therewith.

In addition, the control unit 201 may be arranged to display usage data, either at time of transmission, periodically (in accordance with a specified time period), or in accordance with an explicit request (via a set of selectable menu options), on the projector screen 211.

The transmission of data to the administration centre will now be described, with reference to FIG. 4. At step 401, the control unit 201 checks whether the transmission conditions have been satisfied, namely that both/either a specified time has elapsed and/or that the usage data has changed since data was last sent. If these conditions have been satisfied, the control unit 201 retrieves data from the memory 213, packetises the same (step 403), and proceeds to forward the packets to the transmission unit. Once the control unit 201 has forwarded the packets to the transmission unit, it may empty the local cache 213 (step 404).

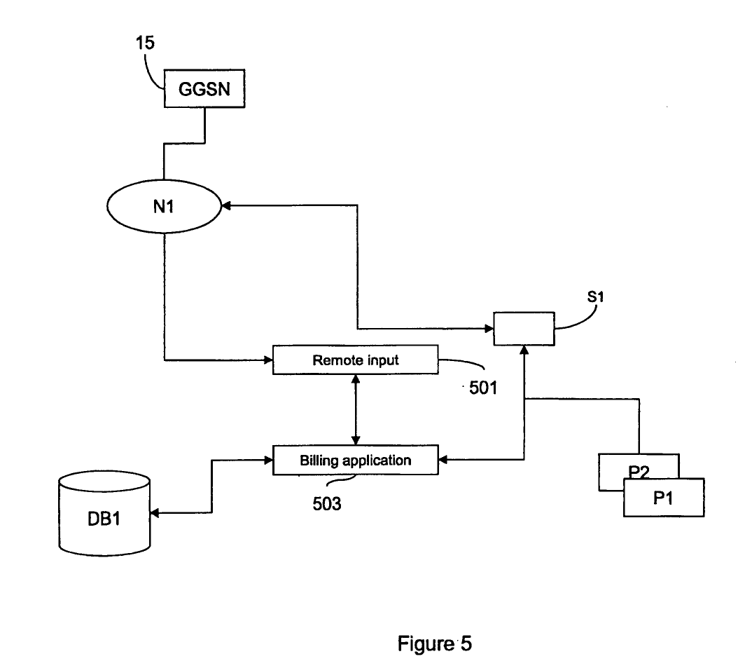

Referring to FIG. 5, the transmission unit TU then transmits the data packets (step 405), which are received by the base station 13 and forwarded, in a known manner, to the remote input 501 (which may be a data server) of the administration centre. Data received at the remote input 501 is forwarded to a billing application 503 running on, for example, an application server located within the administration centre.

The billing application will now be described with reference to FIG. 5, which is a schematic block diagram showing flow of data between the GGSN 15 and the administration centre. As stated above with reference to FIG. 1, the billing application 503 runs on application server S2, and is arranged to receive signals from the remote input 501 and to inter-operate with web server S1 and database DB1. The billing application 503 comprises a computer program, or a suite of computer programs, arranged to receive usage data from the image projector 10 and to covert the usage data into corresponding cost data and store the cost data in a database DB1. Each image projector customer has a database record associated therewith, which stores customer ID, authentication details, usage and corresponding cost data.

The billing application 503 is also operable to receive requests to access the cost data from a remote terminal T1, and may include an authentication routine for authenticating access to the billing application 503. Such requests may be input via a graphical user interface, such as a browser, which runs on the remote terminal T1 and is arranged to send and receive input data to/from web server S1.

In the event that a customer wants to view his most recent usage and cost data, the billing application is arranged to transmit a request for usage data to the control unit 201 of the image projector 10; referring back to FIG. 4, this causes the control unit 201 to step through steps 405, 404 and 405 described above.

Alternatively, a customer may prefer to automatically receive periodic cost updates. Accordingly, the billing application 503 may have access to a plurality of template profiles P1, P2, each of which specifies an update frequency and a preferred mode of notification and which can be selected by a customer via the browser running on his remote terminal T1. For example, a first such profile P1 could specify an update frequency of monthly and a preferred notification mode of SMS, while a second such profile P2 could specify an update frequency of quarterly, and a preferred notification mode of email. The notification frequency and transmission details (SMS and email data) can be input when a customer is selecting a profile, and stored in the database record corresponding to this customer ID.

In order to relay email messages, the billing application 503 has to be capable of sending and receiving SMTP (Simple Mail Transfer Protocol) messages; this can be provided by a software component (not shown) arranged to establish two-way transmission channels to a receiver-SMTP, as is described in Request For Comments (RFC) 821, available from the IETF and at the following uniform resource locator (URL) at May 2003: http://www.ietf.org/rfc/rfc0821.txt.

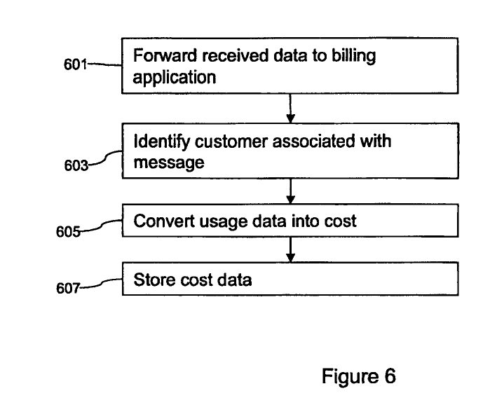

FIG. 6 shows the steps performed by the billing application 503 when it receives usage data at the remote input 501. At step 601, data packets are passed to the billing application 503, which, at step 603, identifies the customer to which the data corresponds. Step 603 involves unencapsulating (and if necessary unencrypting) the packets so as to identify the image projector 10 associated with the received packets. Assuming that the received data relates to a registered customer and is successfully unencrypted, the billing application 503 proceeds to convert (step 605) the usage data into a cost. In one arrangement, the customer could be charged for the total usage time in accordance with a fixed hourly rate (FhR) as follows:
Charge=TuT×FhR.

Alternatively, the customer may be charged in accordance with a scale of charges, for example having an hourly rate which decreases with increased usage time, or any other charging function based on the monitored usage time that the equipment has actually been in use. Having converted the usage data into cost, this is stored (step 607) in the database DB1 in whichever record corresponds to the identified customer. The cost data are then available for access by, or transmission to, the customer.

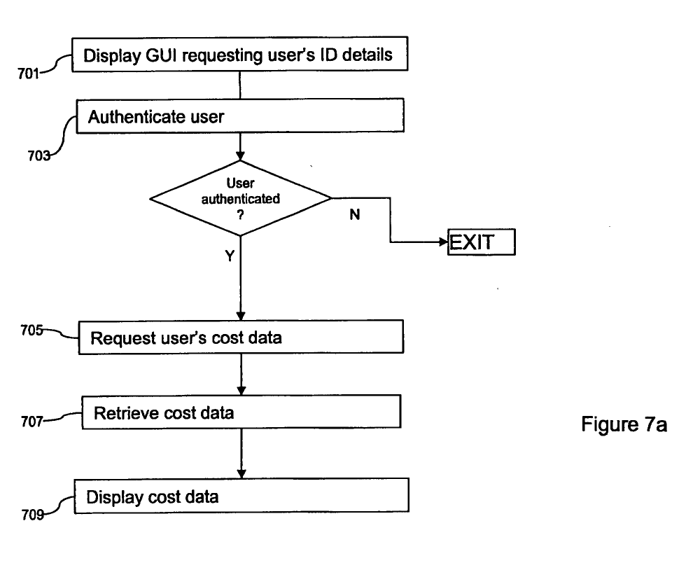

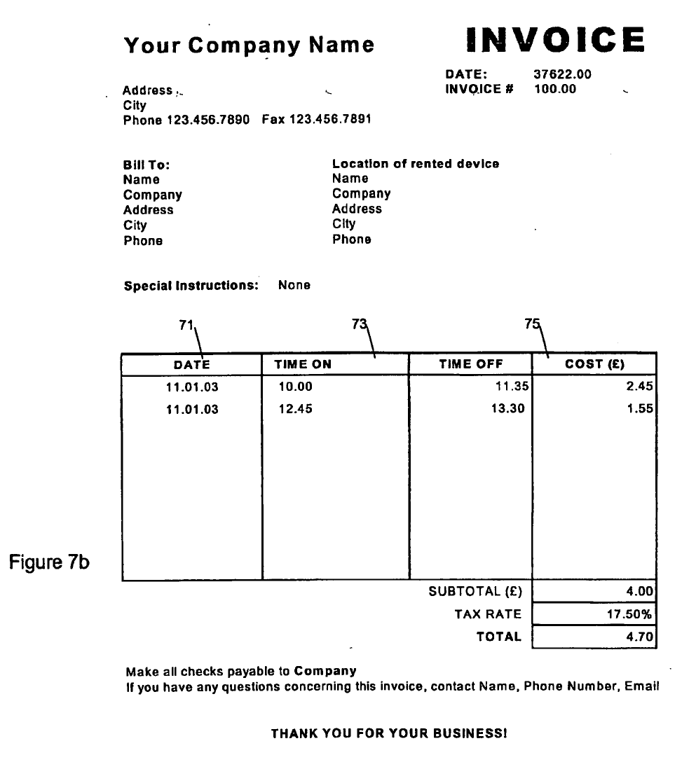

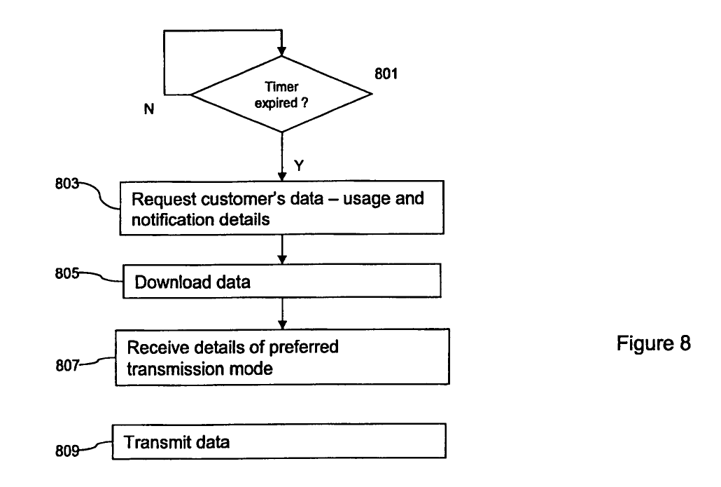

Access to the stored cost data will now be described with reference firstly to FIGS. 7a and 7b, which show steps involved in receiving and processing an explicit request for cost data, and secondly with reference to FIG. 8, which shows steps involved in automatically sending cost data to a customer in accordance with his previously defined profile.

Referring to FIG. 7a, a customer enters an appropriate URL in a browser running on his terminal T1, which causes the web server S1 to serve web pages to the customer's browser, requesting user name and password (step 701). Once the customer has entered his identification details, the web server S1 passes the entered details to the billing application 503 in order to authenticate the customer's request (step 703). Assuming that the customer's request is successfully authenticated, the billing application 503 forms a query (e.g. using SQL (Standard Query Language)) to retrieve data from database DB1 corresponding to the customer, and sends the query to the database DB1 (step 705), which retrieves and downloads the data to the billing application (step 707). Thereafter the billing application 503 transmits the cost data, via the web server S1, to the browser, which displays the same (step 709). In one arrangement, the HTML (or XML) tags within which the cost data are encapsulated cause the browser to display an invoice such as that shown in FIG. 7b.

This invoice is essentially an itemized bill showing individual usage events (date, time on, time off 71, 73, 75) relating to an image projector rental account. When an image projector is leased to a hotel, it may be expected that the hotel itself “hires” the device to several different companies (e.g. for conferences, presentations etc.), and may wish to bill these companies in respect of their individual usage. Accordingly, an account manager for the device, logging onto the billing application 503 via remote terminal T1, can submit a query for cost data in respect of a specific period (e.g. corresponding to day 1 when company 1 was using the device). The invoice returned at step 709 will then relate to that period only. Alternatively the account manager could submit a plurality of queries, each specifying a respective period, so that the data returned at step 709 will comprise a corresponding plurality of individual invoices, each corresponding to its respective period.

Turning now to FIG. 8, in the event that the customer has registered with the billing application 503 as requiring notification of his cost data via automatic cost updates—e.g. via one of the profiles P1 . . . Pn described above—the processing program invokes a system timer in accordance with the update frequency specified by the customer. When the timer has expired, step 801, the processing billing application 503 forms a query (e.g. using SQL (Standard Query Language)) to retrieve data from database DB1 corresponding to the customer, and sends the query to the database DB1 (step 803), which retrieves and downloads the data to the billing application 513 (step 805). At the same time, or shortly thereafter, the billing application 503 retrieves details of the customer's preferred transmission mode and transmission data (such as destination numbers and addresses etc.) (step 807) and transmits the downloaded data in accordance with that data (step 809). For example, in the event that the customer has specified SMS as his preferred mode of delivery, step 809 involves the billing application 503 encapsulating the cost data received at step 805 into an SMS in accordance with the customer details received at step 807.

In the event that the customer has specified email as his preferred mode of delivery, the billing application 503 passes the cost data and specified email address (retrieved at step 807) to the SMTP software component, so that step 809 involves inserting the cost data into either the subject or the body of an email message and sending the email to the specified email address in accordance with the SMTP protocol.

A customer may specify GPRS as his preferred mode of delivery, setting the destination address to that of the image projector 10. Accordingly, when such packets are received by the image projector 10, the control unit 201 can be arranged to display the received data on projector screen 211.

Although the processes have been described with reference to sending cost data as SMS, email and IP data packets, it will be appreciated that these are merely illustrative of possible transmission modes, and that other modes are possible. These include (but are not limited to) paging and recorded voice messages (via DTMF).

As stated above with reference to FIG. 1, an administrator working at local terminal T2 can access the billing application 503 via the web server S1, for example to print off invoices on printer T3. These invoices may then be posted to customers. In addition to storing cost, or debit due, in respect of an image projector, the database DB1 can also be arranged to store credit, or payments made, in respect of the image projector. This data could be accessed by the administrator at local terminal T2 as part of account management procedures. In the event that payment has not been received in respect of an image projector, the billing application (preferably under control of the administrator) has the facility to transmit a control signal to the image projector, causing the device to be disabled until such time as suitable payment has been made.

In the above-described embodiment, the image projector 10 includes the transmission unit TU therein. However, the transmission unit TU could be located in a separate device, such as a portable laptop, which is arranged to connect to the image projector via, e.g. either a bespoke port or an existing (e.g. RS232) port in the image projector, and receive the usage data directly from the control unit 201. Thus in such an arrangement, the laptop transmits the usage data to the billing application 503.

In the above-described embodiment, it is assumed that the image projector 10 is configured to include an in-built usage monitoring system—in the above description the control unit 201 is described as being arranged to record usage of the image projector 10. However, the invention can also be applied to image projectors that are not so configured; in such cases (an) additional device(s) are required to externally monitor usage of the image projector.

An example of such an additional device, referred to as a monitoring unit, will now be described.

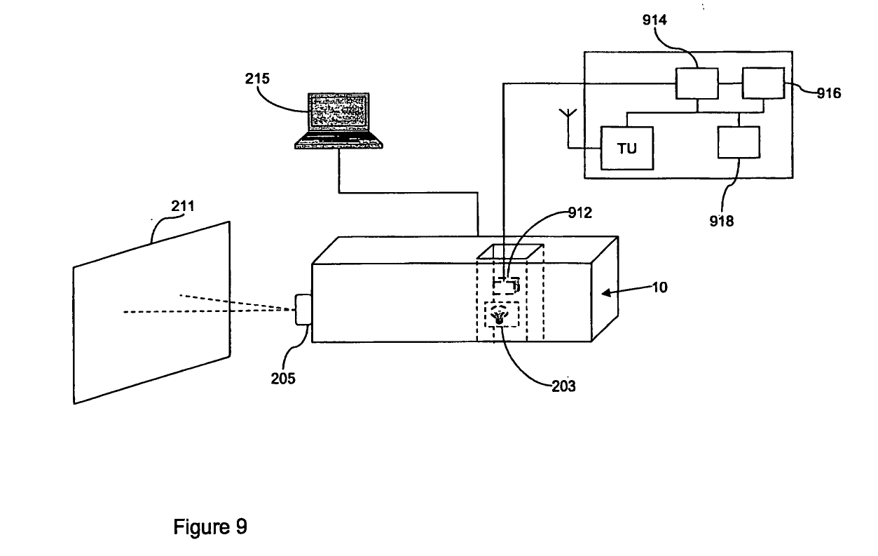

Referring to FIG. 9, the monitoring unit may, for example, be mounted in the lamp cavity of the image projector 10, and include a radiation sensor 912 in the form of a cadmium sulphide (CdS) cell mounted in the unit to detect radiation impinging thereon. The cell 912 is connected to microprocessor controller 914, which uses an external oscillator 916, running at 100 KHz, selected to reduce power consumption of the controller 914 whilst providing sufficiently accurate timing cycles. The oscillator 916 is typically accurate to within 1% and more preferably to within 0.1%. The monitoring unit includes an internal battery 918, and the sensor cell 912 is mounted so as to detect radiation emitted during use of the equipment in which the monitoring unit is housed, and in a location in which the amount of ambient light impinging on the cell when the device is not in use is insufficient to trigger monitoring by the controller 914.

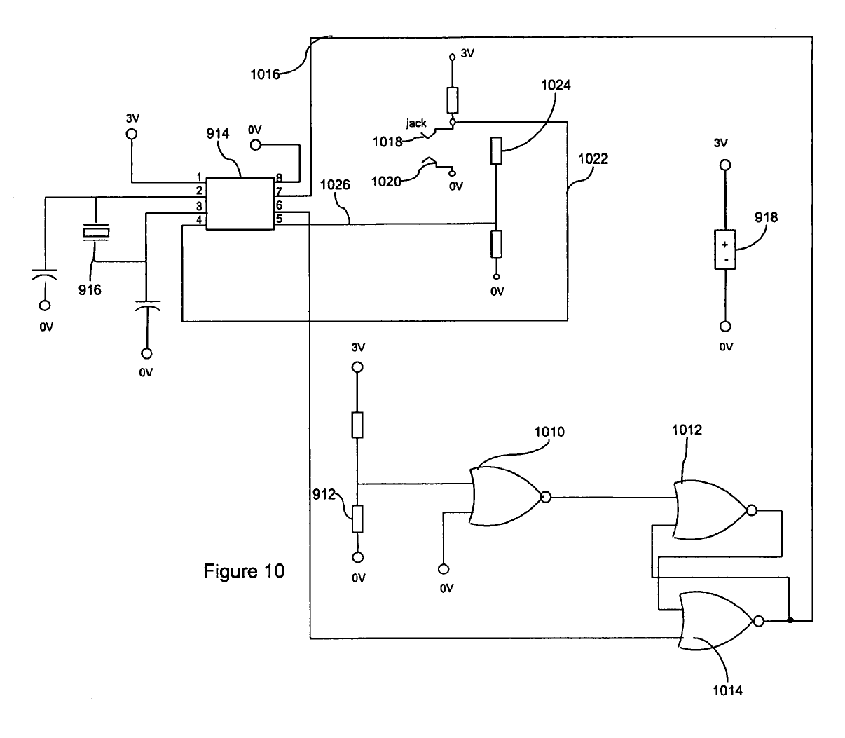

When the lamp is switched on, radiation impinging on the sensor 912 causes the resistance of the cell 912 to fall from in the region of 10 Mohm to around 50 Kohm. Referring to FIG. 10, this fall in resistance causes an input to logic gate 1010 to switch from low to high, and the output from logic gate 1010 is latched in a flip flop latch formed by logic gates 1012 and 1014. The output of sensor output line 1016—from low to high—is sensed by the controller 914, in response to which the controller 914 switches from a relatively low power “sleep” mode to a relatively high power monitoring mode, in which an elapsed time period is monitored. Whilst the output on sensor output line 1016 remains high, a cumulative time period monitored by the controller 914 is incremented using the timing pulses received from oscillator 916. The controller 914 is adapted to monitor elapsed time in preset time periods, for example 1 minute time intervals. At the end of each interval, an attempt is made by the controller 914 to reset the latch previously set by the radiation cell activation. If the lamp 203 is still on the latch cannot be reset, and the output on the sensor output line 1016 remains high. If, on the other hand, the lamp 203 is off, the latch is reset and the controller 914 switches back to a low-power “sleep” mode, during which the elapsed time period is no longer monitored. Thus, the controller 914 gradually builds up a cumulative count of time unit intervals which correspond to the amount of time during which the lamp of the device is switched on, that is to say the monitoring unit monitors usage of the image projectors in terms of periods during which the lamp is switched on. When the device is in standby mode, and the lamp is off, the equipment is taken not to be in use and therefore no usage is registered during usage of the device in a standby state, even though the device may be otherwise powered up.

When the controller 914 is in a “sleep” mode, the oscillation of the oscillator 916 is halted, thereby further reducing power consumption. In this “sleep” mode, the current within the monitoring unit falls to less than 1 μA. On the other hand, during active timing, the count within the monitoring unit is typically 50 μA. The device is typically capable of monitoring active usage of the device, corresponding to periods when the lamp is switched on, of up to 5000 hours in total.

In addition to the above-described monitoring functions, the monitoring unit can include a transmission unit TU of the type described in accordance with the first embodiment of the invention (and variants thereon), and which may, for example, be powered by battery 918. Referring back to FIG. 9, the controller 914 is arranged to store the accumulated time, and, at specified intervals, transmit the data, via the transmission unit TU, to the billing application 503.

Alternatively, the monitoring unit can include components for directly reading out data from the controller 914, in which case the transmission unit TU can conveniently be arranged in operative association with a device (referred to below as a readout unit) arranged to perform such a readout operation. The readout can, for example, be carried out by inserting a jack into a bespoke socket in the monitoring unit (not shown), which connects at contacts 1018, 1020 in the socket, causing a jack sensor line 1022 to switch between a high signal state and a low signal state, which is detected by the controller 914. In response to detection of insertion of a jack, the controller 914 switches between a low-power “sleep” mode and a high-power data readout mode. In the data readout mode, the controller 914 intermittently sends the current timer reading, for example in RS232 format, in a data signal sent out via data line 1026, which connects to the jack via electrical contact 1024.

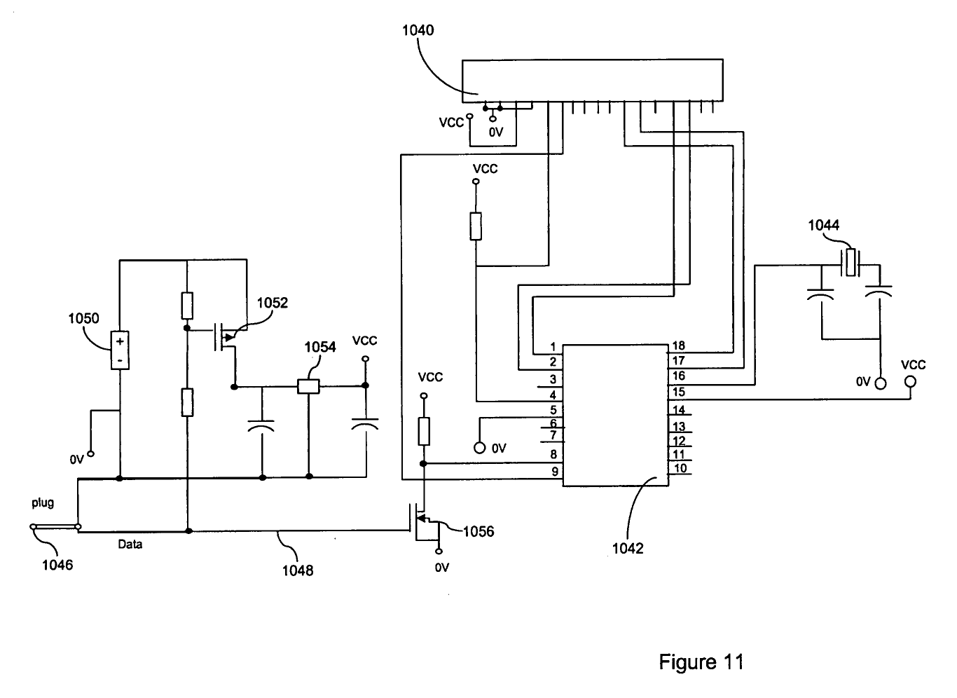

An example of the electrical components forming such a readout unit is shown in FIG. 11. These components include an external oscillator crystal 1044, which runs at a selected cycle rate, for example 100 KHz, ensuring a relatively low-power operation of the readout unit; and a jack 1046 which, when inserted in a corresponding socket in the monitoring unit, interconnects contacts 1018 and 1020 and connects a data line 1048 to the readout electrical contact 1024 in the monitoring unit. The readout unit also includes a battery 1050 which is used to power the electrical components, and a power control circuit which switches the power supply circuit within the readout unit on in response to the sensing of data on data line 1048. The readout unit power is switched on via a gate 1052 and a regulator 1054. On receipt of data via the data line 1048, the data are level shifted by a gate 1056 and received by a readout control unit 1042. The control unit 1042 processes the received data and formats it for transmission by the transmission unit TU. Alternatively or additionally, the control unit 1042 may process the data into a format suitable for display; the readout unit may, for example, include an LCD display 1040, which shows the stored usage in terms of hours and minutes. This latter arrangement is particularly beneficial in cases where rental companies manually retrieve usage data (by means of such a readout unit): when the rental company hands over the device 10 to a customer of the rental company, a reading of the current usage can be taken by plugging the jack 1046 into the relevant socket on the device 10, and thereafter at predetermined intervals either the customer or the rental company can repeat performing the usage readings.

In the event that the customer is a hotel or conference organizer, and has rented a plurality of such devices 10, a single readout unit is preferably designed to cooperate with each of the plurality.

It is to be understood that the monitoring and readout units—as a “retro-fit” unit to a standard display device—are, in their own right, another aspect of the present invention. In other words the monitoring and readout units can operate independently of (i.e. function for purposes other than) the transmission of usage data described above.

It should be noted that all aspects of the invention are not limited to video image projectors. The invention extends to other audio-visual equipment including:
still image projector equipment including overhead projectors and slide projectors;
video displays and monitors, including plasma display screens, cathode ray tube (CRT) screens, liquid crystal display (LCD) screens;
computer equipment (laptop, desktop, server etc.); and
video recording and reproducing equipment including video cameras and video storage devices.

It is to be understood that the control units of these devices will be configured to monitor an attribute which indicates actual usage of the device in order to generate the monitored usage data, and the remainder of the data processing and billing system described above will be used in combination with such control units.

With particular reference to the retro-fit aspect of the invention, where a monitoring unit is installed in the lamp compartment of a device having a lamp which is energized during use, in an alternative embodiment a monitoring unit may be installed in a different type of electronic device. For example, the unit may be installed in a rental portable computer of the type having a screen hingedly attached to a base portion. In this case, the computer has areas, namely by the surfaces which face one and other on the screen and base portion, which are exposed to ambient radiation when in an opened configuration when the device is in use, and which are less exposed to ambient radiation when in a closed configuration when the device is not in use. The monitoring unit may then be installed such that the sensor is located so as to sense ambient radiation when the computer is opened, thus providing a mechanism whereby a signal indicating actual use of the computer may be monitored. A similar arrangement may be used on other devices, in which an opening mechanism is provided, the opening mechanism exposing an area to ambient radiation.

Furthermore, in relation to the second aspect of the invention, the sensor is described as detecting visible radiation emitted by the lamp. This thus uses a reliable characteristic signal indicating the equipment to be in use. In an alternative embodiment, heat radiation from the device may be detected in the form for example of a temperature reading—in this case the monitoring unit may for example be mounted to the outside of the device housing. In this case, use of the equipment is taken to occur when a heat reading above a predetermined threshold is reached. However, it has been found, in particular in devices which use cooling fans during operation, that it can be difficult to distinguish operation in standby mode, with the fan switched off for which preferably no charge is incurred, and fully operative mode with the fan switched on. Hence, locating the monitoring unit inside the lamp housing to detect radiation emitted from the lamp is preferred.

Whilst in the above embodiment the transmission unit TU is configured so as to send usage data as GPRS packets, as an alternative, or in addition, the transmission unit could be configured to send and receive data in accordance with Wireless LAN (WLAN) or Bluetooth protocols. These are short range communication mechanisms, and data can only be sent in accordance therewith when a base station is located sufficiently close to the image projector. For further information relating to implementation of the WLAN standard 802.11, the reader is referred to http://grouper.ieee.org/groups/802/11/, from where a copy of the 802.11 standard can be downloaded. In addition, the user is referred to: “802.11 Wireless Networks: The Definitive Guide to Creating and Administering Wireless Networks” by Matthew Gast, published by O-Reilly in April 2002 (ISBN 0-596-00183-5). For further information relating to implementation of the Bluetooth standard, the reader is referred to “Bluetooth Revealed” by Brent A Miller, published by Prentice Hall in September 2000 (ISBN 0-13-090294-2).

Alternatively, the control unit 201 could transmit the usage data in the form of Short Message Service (SMS) messages instead of, or in addition to, writing to the local memory 213.

As yet a further alternative, the image projector 10 could connect directly to a local area network (LAN), or via a modem to a public switched telephone network (PSTN), and transmit the usage data to the administration centre accordingly.

In relation to the second aspect of the invention, the transmitting unit TU could be embodied in a portable laptop device that connects to the monitoring unit, rather than in the bespoke readout unit.

It is to be understood that any feature described in relation to one embodiment may also be used in other of the embodiments. Furthermore, equivalents and modifications not described above may also be employed without departing from the scope of the invention, which is defined in the accompanying claims.

1. Apparatus for monitoring usage of an image projector, said apparatus comprising:
a usage sensor arranged to sense usage of the image projector; and
a control unit adapted to monitor usage of the image projector in response to an output from said sensor.

2. Apparatus according to claim 1, wherein the control unit is adapted to monitor an elapsed time in which the projector is in use.

3. Apparatus according to claim 1, including a data transmitter for transmitting data indicative of said sensed usage.

4. Apparatus according to claim 3, wherein the data transmitter comprises a wireless radio transmitter.

5. Apparatus according to claim 3, wherein the data transmitter is arranged separate from said image projector.

6. Apparatus according to claim 3, wherein the data transmitter is adapted to transmit data relating to a temporal characteristic of the sensed usage.

7. Apparatus according to claim 6, wherein said temporal data includes data indicative of duration of one or more sensed periods of usage.

8. Apparatus according to claim 6, wherein said temporal data includes data indicative of a start time and an end time of a sensed period of usage.

9. Apparatus according to claim 1, in which the apparatus is arranged to initiate transmission of sensed usage data in response to conditions satisfying one or more predetermined criteria.

10. Apparatus according to claim 1, wherein the usage sensor is integral to the image projector.

11. Apparatus according to claim 1, wherein the usage sensor is removably connectable to the image projector.

12. Apparatus according to claim 1, including a data receiver arranged to receive remotely generated control signals for use in controlling operation of the image projector.

13. Apparatus according to claim 12, wherein the apparatus is arranged to disable operation of the image projector in response to receipt of a disabling control signal.

14. Apparatus according to claim 12, wherein the data receiver is arranged to receive a remotely generated request for usage data and the apparatus is arranged, in response thereto, to retrieve stored usage data for transmission.

15. Apparatus according to claim 1, wherein the usage sensor is adapted to sense radiation which is emitted as a result of an image being generated by the projector.

16. Apparatus according to claim 1, wherein the usage sensor is adapted to sense radiation emitted from a lamp in the projector.

17. Apparatus according to claim 1, wherein the usage sensor is adapted to sense heat radiation.

18. Apparatus according to claim 1, wherein the usage sensor is in the form of a cadmium sulphide (CdS) sensor.

19. Apparatus according to claim 1, further comprising a display unit which is adapted to receive data from said control unit and to display a usage reading based on the usage monitored by the control unit.

20. Apparatus according to claim 19, wherein the display unit is removably connectable to the control unit.

21. Apparatus according to claim 20, wherein the display unit has a power control circuit providing a low power mode and a high power mode, and wherein the control circuit is adapted to switch the display unit between the low power mode and the high power mode in response to connection of the control unit thereto.

22. A data processing system for processing data relating to usage of audio-visual equipment, the data processing system comprising:
a data receiver arranged to receive said data indicative of usage of audiovisual equipment;
accounting means arranged to evaluate a cost associated with said usage on the basis of a predetermined charging function; and
output means arranged to output the evaluated cost,
wherein said received data includes data relating to a temporal characteristic of the usage of the audio-visual equipment.

23. A data processing system according to claim 22, wherein the system includes receiving means arranged to receive a request for cost data relating to said usage, wherein the output means is arranged to output the evaluated cost data in response to receipt of said request.

24. A data processing system according to claim 23, wherein the request comprises an automatically generated request.

25. A data processing system according to claim 23, wherein the request includes data defining a time period in respect of which cost data are required.

26. A data processing system according to claim 22, wherein the output medium is any one of SMS, GPRS, TCP/IP.

27. A data processing system according to claim 22, including control signal generating means arranged to generate a control signal for controlling image projectors, wherein the system is arranged to output the generated control signal to the audio-visual equipment.

28. A data processing system according to claim 27, wherein the control signal generating means is arranged to generate a said control signal in response to conditions satisfying one or more predetermined criteria.

29. A data processing system according to claim 27, wherein the control signal comprises a signal arranged to disable the audio-visual equipment.

30. A method of monitoring usage of an image projector, including:
sensing usage of the image projector;
transmitting data indicative of said sensed usage to a processing system; and
processing the sensed usage data on the basis of a predetermined cost criterion so as to identify a cost associated therewith;
in which said transmitted data includes data relating to a temporal characteristic of the monitored usage.

31. A method according to claim 30, further including receiving a request for cost data relating to specified an image projector; accessing the processed cost in respect of the specified an image projector; and outputting the same.

32. A method according to claim 30, in which usage of the image projector relates to usage thereof by a customer, the method including monitoring payment by the customer in respect of said usage.

33. A method according to claim 32, including evaluating said monitored payment in accordance with a predetermined payment criterion and transmitting a control signal to the image projector in dependence on the evaluation.

34. A method for the rental of electronic equipment, in which a customer is provided with electronic equipment over an extended period, and the image projector is provided with a usage monitoring system adapted to monitor usage of the image projector, whereby a signal indicating actual usage of the equipment during the extended period is monitored, and the customer is charged in accordance with a temporal characteristic of the monitored signal.

35. A method according to claim 34, including transmitting the monitored signal to a remote processing system, and charging the customer in accordance with the monitored usage.

36. A method according to claim 34, in which monitoring usage of the image projector comprises monitoring radiation emitted during usage thereof.

37. Apparatus for monitoring usage of audio-visual equipment, said apparatus comprising:
a usage sensor arranged to sense usage of the audio-visual equipment; and
a control unit adapted to monitor usage of the audio-visual equipment in response to an output from said sensor.

38. Apparatus according to claim 37, in which the audio-visual equipment comprises a device having an area which is exposed to ambient radiation when in a configuration in which the device is in use, and which is less exposed to ambient radiation when in a configuration in which the device is not in use, and wherein the sensor is located to sense said ambient radiation in said area.

39. Apparatus according to claim 38, wherein the audio-visual equipment comprises an opening mechanism which exposes said area to ambient radiation.

40. Apparatus according to claim 39, wherein the device is a portable computer having a screen hingedly attached to a base portion.
